(19) United States
(12) Patent Application Publication
(10) Pub. No.: US 2026/0070233 A1
(43) Pub. Date: Mar. 12, 2026

(54) SUCTION CUP ASSEMBLY FOR A ROBOT END EFFECTOR

(71) Applicant: Ocado Innovation Limited, Hatfield (GB)

(72) Inventors: Anthony CONTE, Toronto (CA); Tyson RINGOLD, Toronto (CA)

(21) Appl. No.: 18/882,310

(22) Filed: Sep. 11, 2024

(51) Int. Cl. B25J 15/06; B25J 15/02

(52) U.S. Cl. CPC B25J 15/0683; B25J 15/0213

(57) ABSTRACT

A suction cup assembly for a robot end effector, the suction cup assembly comprising a first suction cup, a second suction cup, and a valve assembly. The valve assembly comprises an inlet and first and second flow channels in respective fluid communication with the first and second suction cups. The first and second flow channels are movable to activate the first or second suction cup, in dependence on alignment of the inlet with the respective first or second flow channel, when vacuum pressure is supplied to the inlet in use.

### TECHNICAL FIELD

The present disclosure relates generally to suction cup assemblies for use as part of a robot end effector, for example on a robotic manipulator.

### BACKGROUND

Online retail businesses selling multiple product lines, such as online grocers and supermarkets, require systems that are able to store tens or even tens of thousands of different product lines. The use of single-product stacks therefore can be impractical, since a very large floor area would be required to accommodate all of the stacks required. Furthermore, it can be desirable only to store small quantities of some items, such as perishables or infrequently ordered goods, making single-product stacks an inefficient solution.

PCT Publication No. WO2015/185628A (Ocado) describes a known storage and fulfilment system in which stacks of bins or containers are arranged within a framework structure. The bins or containers are accessed by load-handling devices operating on tracks located on the top of the frame structure. The load-handling devices are configured to lift bins or containers out from the stacks. Multiple load-handling devices can co-operate to access bins or containers located in the lowest positions of the stack. A system of this type is illustrated schematically in FIGS. 1 to 5 of the accompanying drawings.

FIG. 1 illustrates a framework structure 1 of a grid-based automated storage and retrieval system. The structure 1 comprises a number of upright members 3 supporting two sets of transversely arranged horizontal members 5, 7. The upright members 3 extend parallel to one another in the illustrated z-axis and stand orthogonally with respect to the horizontal members 5, 7. The first set of horizontal members 7 extend in the direction of the illustrated x-axis, while the second set of horizontal members 5 extend in the direction of the illustrated y-axis. The two sets of horizontal members 5, 7 form a grid pattern defining a plurality of grid cells. In the illustrated example, storage containers 9 are arranged in stacks 11, with each stack 11 being located beneath a respective grid cell.

FIG. 2 shows a large-scale plan view of a section of transverse track structure 13 forming part of the storage structure 1 illustrated in FIG. 1. The track structure 13 is located on top of the sets of horizontal members 5, 7. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the direction of the illustrated x-axis and a second set of tracks 19 which extend in the direction of the illustrated y-axis. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure 13 are also envisaged.

FIG. 3 shows a plurality of load-handling devices 31 moving on top of the storage structure 1 illustrated in FIG. 1. The load-handling devices 31, which may also be referred to as robots or bots, are provided with sets of wheels to engage with corresponding x- or y-direction tracks 17, 19 to enable the bots 31 to travel across the track structure 13 and reach specific grid cells. The illustrated pairs of tracks 17, 19, are separated by channels 21, 23, allowing the bots 31 to occupy or pass one another on neighbouring grid cells without colliding.

As illustrated in FIG. 4, a bot 31 comprises a body 33 on which are mounted one or more components which enable the bot 31 to perform its intended functions. These functions may include moving across the storage structure 1 on the track structure 13 and raising or lowering storage containers 9 (e.g. from or to stacks 11) so that the bot 31 can retrieve or deposit storage containers 9 in specific locations defined by the grid pattern. The bot 31 further comprises first and second sets of wheels 35, 37 which are mounted on the body 33 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (the side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (the side and further two wheels 37 not visible in FIG. 4). The wheels 37 engage with tracks 19 and are rotatably mounted on the body 33 of the bot 31 to allow the bot 31 to move along the tracks 19. The bot 31 also comprises container-lifting means, generally designated by 39, configured to raise and lower containers 9. The container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with corresponding features of the containers 9. For instance, the containers 9 may be provided with one or more apertures in their upper sides with which the engaging means can engage. Alternatively or additionally, the container engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the bot 31 has an upper portion 45 and a lower portion 47. The upper portion 45 is configured to house the one or more operation components (not shown) that enable the bot 31 to perform its intended functions, and the lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first or second set of wheels 35, 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 to bring the at least one set of wheels 35, 37 out of and into contact with the tracks 17, 19. In some examples, only one set of wheels 35, 37 is configured to be raised and lowered, and the act of lowering the one set of wheels 35, 37 may effectively lift the other set of wheels 35, 37 clear of the corresponding tracks 17, 19, while the act of raising the one set of wheels 35, 37 may effectively lower the other set of wheels 35, 37 into contact with the corresponding tracks 17, 19. In other examples, both sets of wheels 35, 37 may be capable of being raised and lowered, advantageously meaning that the body 33 of the bot 31 stays substantially at the same height and therefore the weight of the body 33 and the components mounted thereon does not need to be lifted and lowered by the wheel-positioning mechanism.

As shown in FIG. 3, a plurality of identical load-handling devices 31 are provided, so that each load-handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers 9 transported to a port by a load-handling device 31 can be transferred to another location by the conveyor system, for example to a picking station (not shown). Similarly, containers 9 can be moved by the conveyor system to a port from an external location, for example to a container-filling station (not shown), and transported to a stack 12 by the load-handling devices 30 to replenish the stock in the system.

Each load-handling device 31 can lift and move one container 9 at a time. If it is necessary to retrieve a container 9 (“target container 9”) that is not located on the top of a stack, then the overlying containers 9 (“non-target containers 9”) must first be moved to allow access to the target container 9. This is achieved in an operation referred to hereafter as “digging”. During a digging operation, one of the load-handling devices 31 sequentially lifts each non-target container 9 from the stack 11 containing the target container 9 and places it in a vacant position within another stack 11. The target container 9 can then be accessed by the load-handling device 31 and moved to a port for further transportation.

Each of the load-handling devices 31 is under the control of a central computer. Each individual container 9 in the system is tracked so that it can be retrieved, transported and replaced as necessary. For example, during a digging operation, the locations of each of the non-target containers 9 is logged, so that the non-target containers 9 can be tracked.

The system described with reference to FIGS. 1 to 5 has many advantages and is suitable for a wide range of storage and retrieval operations. In particular, it allows very dense storage of product, and it provides a very economical way of storing a wide range of different items in the containers, while allowing reasonably economical access to all of the containers 9 when required for picking.

With reference to FIG. 6, the system may further comprise a robotic picking station, generally designated by 50, mounted on top of the storage structure 1, alongside the load-handling devices 31 (not shown). The robotic picking station 50 comprises a robotic manipulator 52 comprising a robotic arm 54 and an end effector 56 for releasably engaging a product to be manipulated, together with several designated grid cells 60, 62. The robotic manipulator 52 is mounted on a plinth 58 above a single grid cell 60 and, depending on its location on the structure 1, can be surrounded by up to eight other grid cells 62. In general, the robotic manipulator 52 is configured to pick an item or product from any one of the containers 9 located in one of the designated grid cells 62 and place it in a container 9 located in another one of the cells 62. The load-handling devices 31 collect containers 9 from, and deliver them to, the designated grid cells 62 as necessary. In this way, the robotic picking station 50 and the load-handling devices 31 work in conjunction to fulfil a customer order or redistribute products throughout the structure 1. The end effector 56 comprises a suction cup 64 connected to a vacuum source (not shown) via a stem 65, enabling the suction cup 64 to engage products or items using vacuum pressure.

### BRIEF DESCRIPTION OF THE DRAWINGS

These and other aspects will now be described, by way of example only, with reference to the accompanying drawings, in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 each show a schematic depiction of a load-handling device interacting with a container;

FIG. 6 shows a schematic depiction of a known robotic picking station;

FIGS. 7A-C show isometric views of a robot end effector in accordance with an embodiment;

FIG. 8 shows an isometric view of a pivotable suction cup assembly as part of the end effector of FIGS. 7A-C;

FIGS. 9A and 9B show an isometric view and cross section, respectively, of a suction cup assembly comprising a valve assembly according to an embodiment;

FIGS. 10A and 10B show an isometric section and cross section, respectively of the suction cup assembly of FIGS. 9A-9B in a different configuration;

FIG. 11A shows an isometric view of a robot end effector including an exhaust element, connectable to the vacuum manifold of the robot end effector, in accordance with an embodiment;

FIGS. 11B-C show an isometric view and a section view, respectively, of the vacuum manifold of FIG. 11A, also including the connectable exhaust element, with the section view of FIG. 11C showing a vacuum generator housed in the vacuum manifold;

FIGS. 12A-B show isometric views of a robot end effector in respective configurations according to an embodiment;

FIGS. 13A-C show isometric views of a finger gripper assembly, as part of the end effector of FIGS. 12A-B, in respective configurations according to an embodiment; and

FIGS. 14A-B show isometric views of the robot end effector of FIGS. 12A-B in a different operating mode.

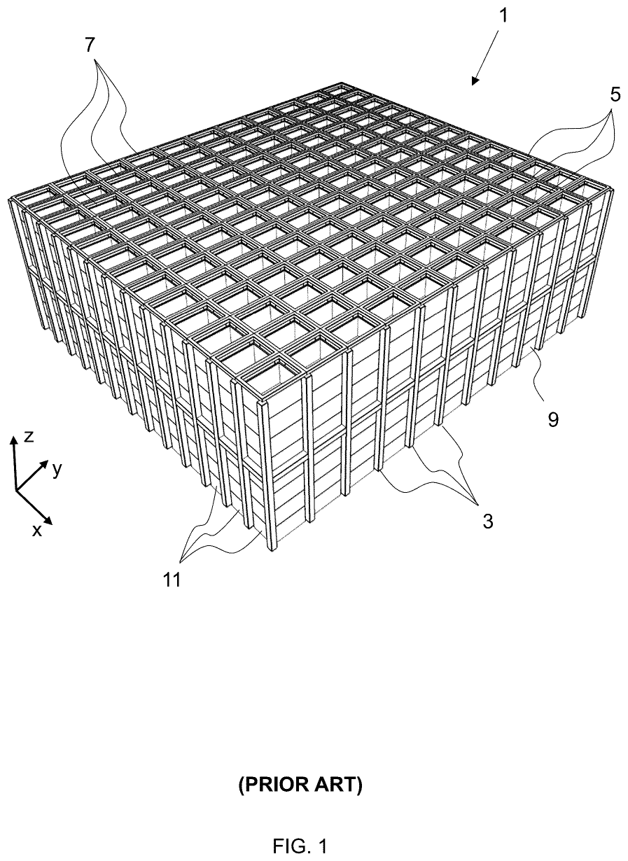

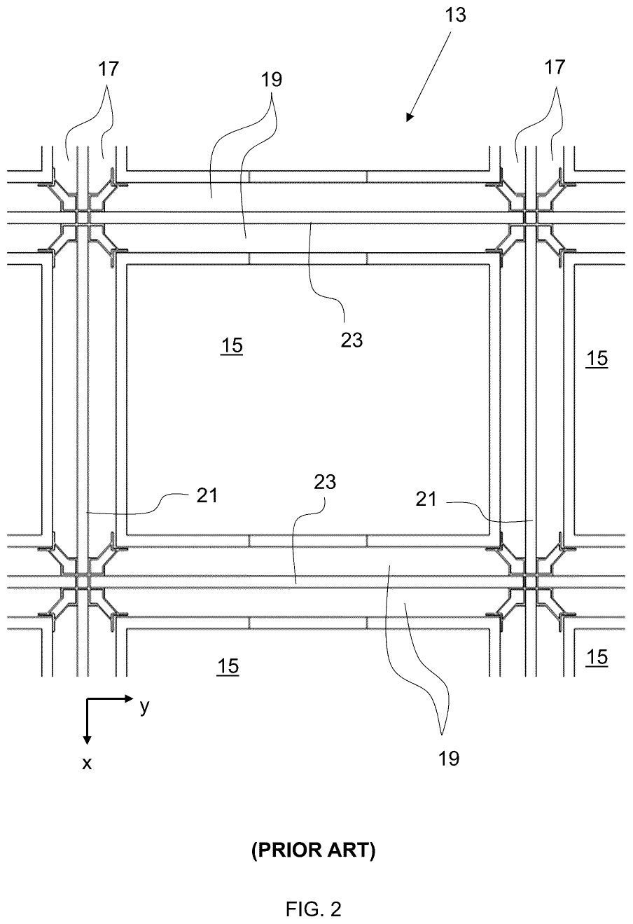

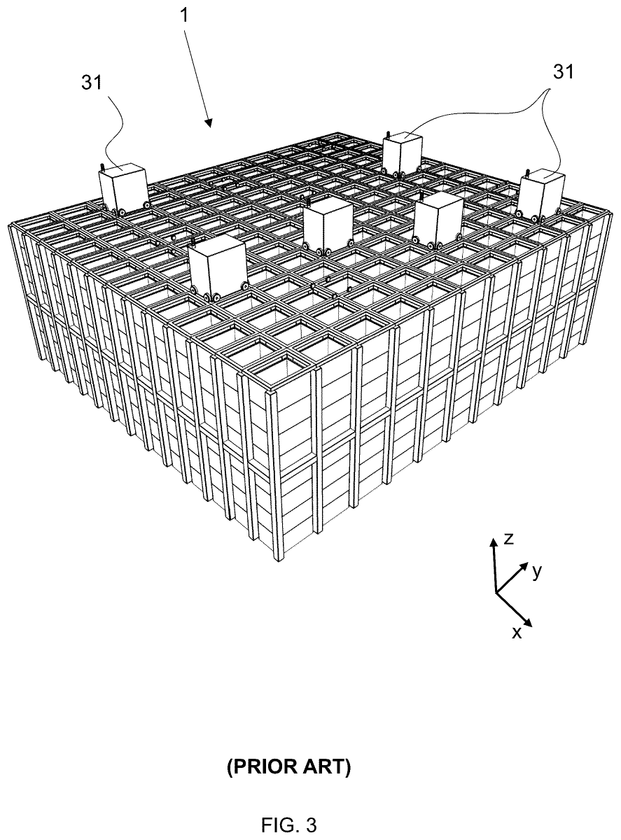

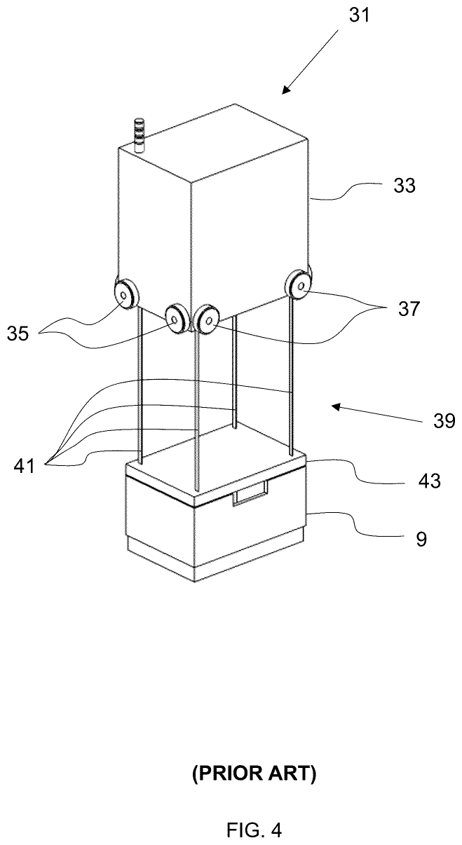

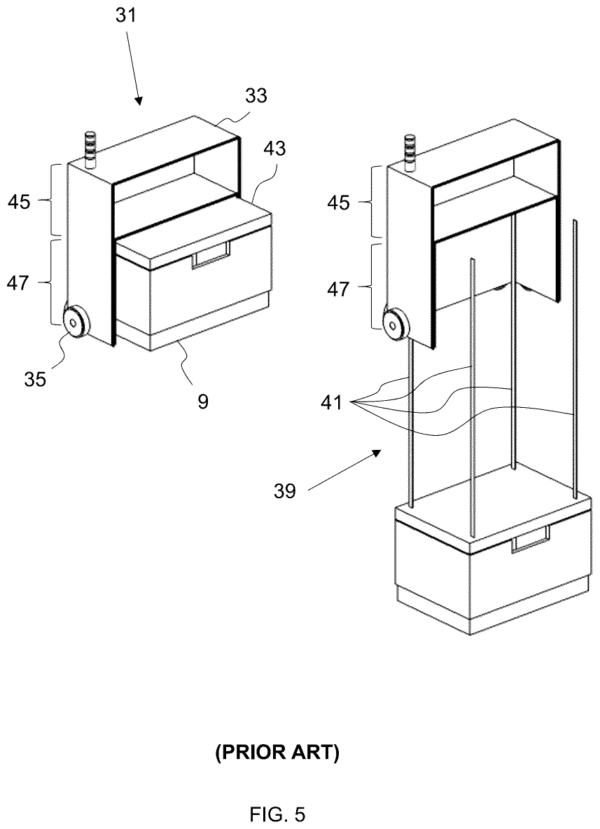

In the drawings, like features are denoted by like reference signs where appropriate.

### DETAILED DESCRIPTION

In the following description, some specific details are included to provide a thorough understanding of the disclosed examples. One skilled in the relevant art, however, will recognise that other examples may be practised without one or more of these specific details, or with other components, materials, etc., and structural changes may be made without departing from the scope defined in the appended claims. Moreover, references in the following description to any terms having an implied orientation are not intended to be limiting and refer only to the orientation of the features as shown in the accompanying drawings. In some instances, well-known features or systems, such as processors, sensors, storage devices, network interfaces, fasteners, electrical connectors, and the like are not shown or described in detail to avoid unnecessarily obscuring descriptions of the disclosed embodiment.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the terms “a”, “an”, and “the” include plural referents unless the content clearly dictates otherwise. It should also be noted that the term “or” is generally employed in its sense including “and/or” unless the content clearly dictates otherwise.

### Robot End Effector

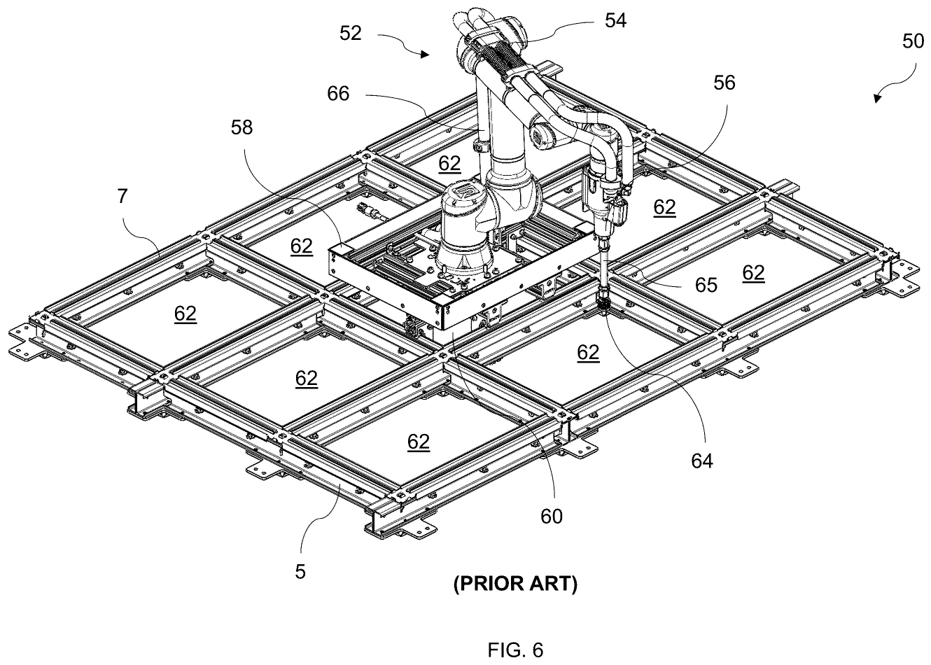

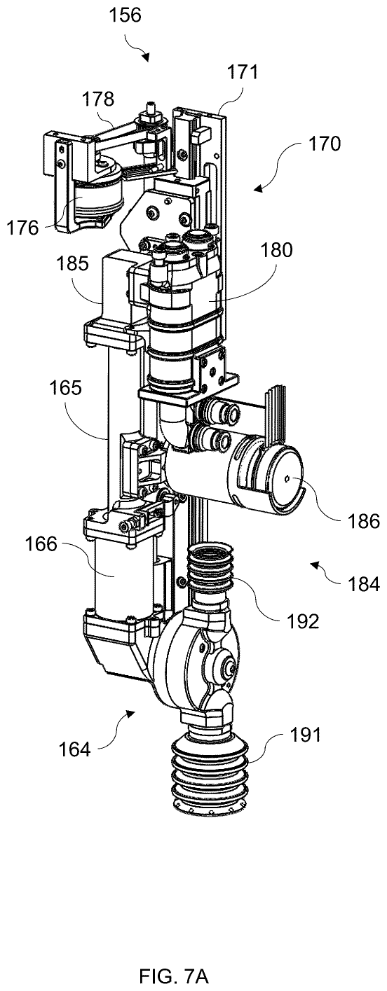

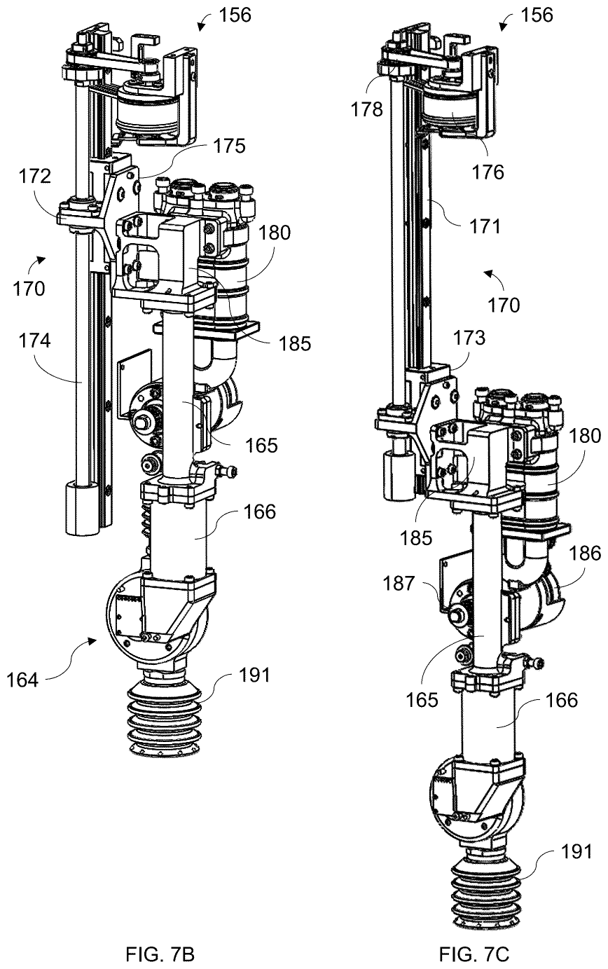

FIGS. 7A-7C show schematic depictions of a robot end effector 156, e.g. an end effector suitable for use with a robotic arm such as the robotic arm 54 shown in FIG. 6.

In one aspect, the robot end effector 156 includes an extendable stem 165, fluidically connectable to a suction cup assembly 164, and a vacuum manifold 180 fluidically connected to the extendable stem 165. The vacuum manifold 180 is configured to supply vacuum pressure to the suction cup assembly 164, via the extendable stem 165, when the end effector 156 is used to releasably engage an item. The stem 165 is hollow to provide a passage for the vacuum pressure between the vacuum manifold 180 and the suction cup assembly 164.

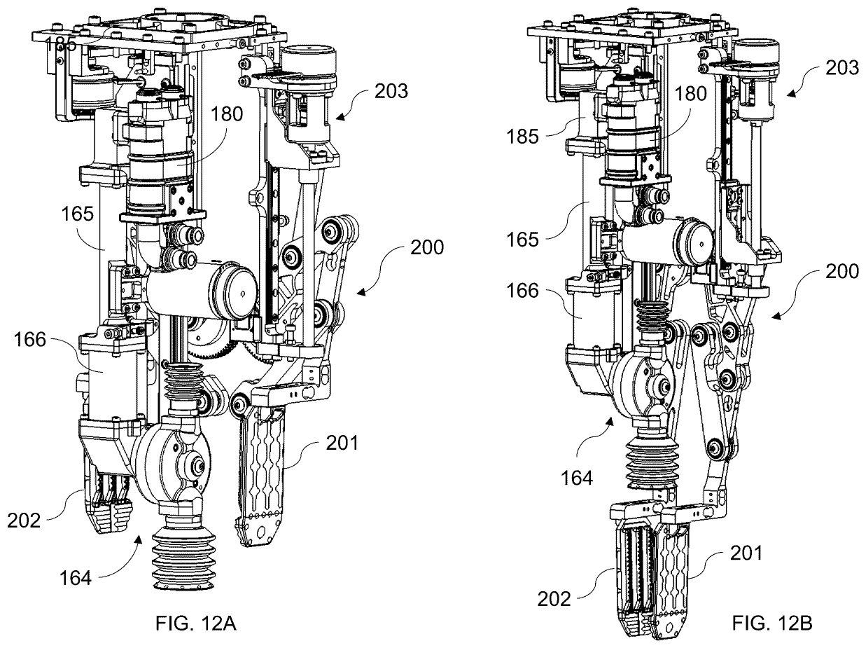

The stem 165 is also movable to extend and retract—e.g. by an actuator, shown in more detail in FIGS. 7B and 7C—and the vacuum manifold 180 is mounted to the stem 165 so as to be movable therewith. In this example, the extendable stem 165 is of a fixed length and extends away from (and is withdrawn towards) the robotic manipulator, upon which it is mounted, by the action of the actuator. Thus, the end effector 156 is made longer or shorter by the movement of the stem 156 away from or towards the mounting by which the end effector 156 attaches to the robot (shown in more detail in the embodiment of FIGS. 12A-B).

In other examples (not shown), the stem 165 is of variable length, e.g. by a telescopic arrangement, such that the stem 165 is extendable and retractable by varying the length of the stem 165 itself. For example, the end effector 156 is made longer or shorter by the lengthening or shortening of the stem 156 relative to its mounting to the robot.

The vacuum pressure supplied from the vacuum manifold 180 may be generated by an external or integrated vacuum source, e.g. one or more vacuum generators. The use of the manifold 180 reduces the need for additional fittings or air lines to fluidically connect the vacuum source to the suction cup assembly, minimising vacuum losses through the low pressure circuit. For example, where an array of vacuum generators is used as the vacuum source, the vacuum manifold 180 provides a single supply to the stem 165 upon which the suction cup assembly 164 may be mounted. This reduces potential vacuum losses compared to individually connecting the one or more vacuum generators to the stem 165 or suction cup assembly 164 to provide vacuum pressure thereto.

Mounting the vacuum manifold 180 to the stem 165, so that it can move therewith through extension and retraction of the stem 165, means that the vacuum source can be located away from the end effector or the robot completely. This provides flexibility for the setup of the robotic manipulator, e.g. any external vacuum generation source could be used in conjunction with the vacuum manifold 180 with minimal effect on the end effector arrangement. For example, venturi vacuum generators could be used in one setup, while an electrical vacuum pump could be employed at a different site where compressed air is not available. The end effector provided could be used in either scenario, e.g. with one or more vacuum lines fed into the vacuum manifold, with the single output fluidically connected to the stem 165. Furthermore, with an external vacuum source, the vacuum manifold 180 mounted to the stem 165 can be made more compact to reduce the space taken up by the end effector during picking operations (e.g. its bulkiness).

In the example end effector 156 shown in FIGS. 7A-7C, the vacuum manifold 180 comprises an integrated vacuum source to generate, in use, the vacuum pressure that is supplied to the suction cup assembly 164 via the stem 165. Integrating the vacuum source at the end effector reduces the pressure drop between the vacuum source and suction device of the end effector, when connected, compared to other systems. For example, the effective length of the vacuum line between the vacuum source and the end effector, and any suction device thereof, is reduced compared to other systems where the vacuum source is positioned further from the end effector. For example, in other systems the vacuum source may be located away from the robotic arm, or mounted on the robotic arm, and connected thereto by a vacuum line of tubing, which can be in the order of several metres long. A shorter effective vacuum line means less power is needed to generate an equivalent vacuum pressure (or suction force) at the suction device, due to the smaller pressure drop.

In the depicted embodiment, the integrated vacuum source comprises a pair of venturi vacuum generators. In other examples, there may be more vacuum generators, e.g. arranged as an array, or only a single vacuum generator. The venturi generators, in this case two in parallel, are housed within a chamber of the manifold 180. Each of the venturi generators includes a venturi restriction and one or more holes in its sidewall, providing fluid communication between the respective venturi restriction and the chamber.

The chamber comprises an opening, in fluid communication with the venturi restrictions, to provide a passage for the vacuum pressure to the stem 165. In the depicted embodiment, the vacuum manifold 180 is mounted to the stem 165 by a mount 185 which defines a generally passage between the opening in the chamber of the manifold 180 and the hollow interior of the stem 165 when connected therebetween. The mount 185 has respective flanges which are bolted to the manifold 180 and the stem 165 to position them relative to one another and line up the internal passage for propagation of vacuum pressure from the venturi generators housed in the manifold 180 to the stem 165 and on to the suction cup assembly 164 when connected at the other end thereof.

The passage through the mount 185 is generally L-shaped since the manifold 180 is mounted thereto so as to be substantially aligned with the stem 165—the venturi generators housed therein are arranged parallel to the stem 165, for example—with the opening being on a side of the manifold 180. Other orientations of the manifold 180 and stem 165 are possible, however, with the mount 185 and its passage being shaped appropriately to duct the opening in the manifold 180 to the stem 165.

The embodiment shown in FIGS. 7A-C includes an optional Inline filter assembly 166 connected to the extendable stem 165 and to the suction cup assembly 164. The inline filter assembly 166 is connectable between the suction cup assembly 164 and the extendable stem 165, for example.

The inline filter assembly 166, in fluid communication with the suction cup assembly 164, acts to filter material sucked into the vacuum line at the suction cup 191, 192 which could damage the vacuum system. Placing the inline filter assembly 166 closer to the suction cup assembly 164 may reduce the effective length of vacuum line which is susceptible to clogging up from loose material in the environment sucked in by the suction cup 191, 192. For example, in the context of a robotic picking station for picking grocery items, the integrated inline filter assembly 166 can protect the upstream vacuum system, e.g. including the vacuum source, from leaked liquids, semi-solids, colloids, gels, etc., that may be sucked into the vacuum line by the suction cup 191, 192 during a picking operation. Integrating the inline filter assembly 166 into the end effector, e.g. at a distal end of the vacuum stem 165, such that it is located between the suction cup assembly 164 and vacuum source can thus help protect the vacuum source. In examples, a body of the inline filter assembly 166, within which a filter element is housed, may be translucent or transparent such that a determination of whether something has been sucked up into the inline filter assembly 166 can be made based on a visual inspection of the filter assembly 166, e.g. by a camera. The camera may be mounted on the end effector 156, for example. This visual check could be automated, e.g. using machine learning based on the image data feed from the camera.

In the depicted embodiments, the stem 165 is also connected to an actuator 170 for extending and retracting the stem in use. FIGS. 7B and 7C show a ball screw actuator 170 comprising a ball screw nut 172 which is movable along a ball screw shaft 174 that is rotatable about its longitudinal axis by a motor 176. The ball screw shaft 174 has one of a right- or left-hand helical raceway upon which the ball screw nut 172, which has a complimentary helical raceway, is movably mounted. The motor 176 (e.g. a stepper, servo, or DC motor) drives the ball screw shaft 174 by a belt 178 in this example, but may instead drive the shaft 174 by a gear mechanism or be directly coupled to the shaft 174 to provide the rotational motion. The stem 165 is mounted onto the movable nut 172 by the mount 185 such that linear movement of the nut 172 along the ball screw 174 extends and retracts the stem 165. FIG. 7B shows the stem 165 in a more retracted position, whereas FIG. 7C shows the stem 165 in a more extended position with the nut 174 having travelled towards the lower end of the shaft 174 of the ball screw actuator 170.

In this example, the actuator 170 further comprises a guide rail 171 and a carriage assembly 173, movably mounted to the guide rail 171, to which the ball screw nut 172 is connected. The guide rail 171 functions, in part, to guide the linear movement of the stem 165 which is also connected to the carriage assembly 173 by a support member 175 arranged to connect the ballscrew nut 172 and the mount 185. The guide rail 171 may also function to prevent the ball screw nut 172 from rotating when the ball screw shaft 174 is rotated, fixing the rotational position of the ball screw nut 172.

The example effector 156 may also comprise a magnetic encoder (not shown in the Figures) mounted on a motor shaft of the actuator 170. The magnetic encoder is for determining a position of the extendable stem 165, e.g. by relating an amount of rotation for the motor shaft of the motor 176 driving the actuation to an amount of linear travel of the ball screw nut 172 along the shaft 174 and thereby an amount of extension of the stem 165. Thus, the position of the stem 165 is tracked indirectly through the magnetic encoder on the motor shaft. Furthermore, in some examples, a preset “zero” position is determinable using a proximity (or “home”) sensor at the top of the ball screw mechanism stroke, with the position then tracked incrementally from there.

When not in use, the stem 165 is retractable towards the body of the end effector 156 until the home sensor is triggered. When using suction to grasp an item, the motor 176 can rotate the ball screw shaft 174 to extend the stem assembly 165 to the desired position. While the vacuum is active, the stem 165 can be actively retracted while grasping the item. Also, by being backdrivable, the stem actuator 170 may operate with compliance such that overdriving the robot arm into an item can be accommodated.

### Pivotable Suction Cup Assembly

In another aspect, the robot end effector comprises a pivotable suction cup assembly 164 and a belt drive 184 connected to the suction cup assembly 164 to pivot the suction cup assembly 164 in use. The belt drive 184 enables the pivoting of the suction cup assembly 164, such that the end effector 156 can approach an item at different selectable angles, for example, while displacing the weight and volume of the motor away from the suction cup assembly 164 itself. In this way, the weight and volume of the suction cup assembly 164 can be kept low, e.g. compared to directly mounting the motor to the suction cup assembly 164, which is advantageous in situations where an item is to be grasped from a collection of other items or obstacles.

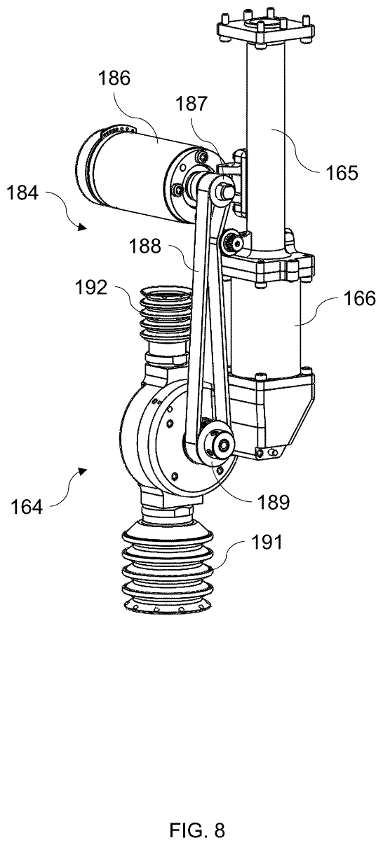

In the embodiment depicted in FIG. 8, the belt drive 184 comprises a motor 186 and a driving pulley 187 displaced above the suction cup assembly 164 and a belt 188 connectable between the driving pulley 187 and the suction cup assembly 164. Thus, the motor 186 is able to drive the suction cup assembly 164, via the belt 188, to make it pivot, e.g. rotate about its axis. The suction cup assembly 164 also comprises a driven pulley 189 connectable to the belt 188 of the belt drive 184 in this example.

In the depicted embodiment, the suction cup assembly 164 generally has a cylindrical, or disc, form and is pivotable by rotating about a central axis perpendicular to the end faces of the cylinder. Though the example suction cup assembly 164 shown in the Figures has two suction cups, the pivotable suction cup assembly 164 may have one or more suction cups in other embodiments of the end effector. The one or more suction cup is positioned on the curved face of the cylindrical assembly 164 such that pivoting the assembly 164 changes an angle of the one or more suction cup. This can be utilised when selecting a grasp point for an object to be engaged by the one or more suction cups of the end effector.

The two suction cups of the suction cup assembly 164 in the depicted embodiment include a first suction cup 191 and a second suction cup 192 angularly displaced from the first suction cup 191 about the suction cup assembly 164. The first suction cup is at least one of a different size or compliance to the second suction cup, e.g. FIG. 7A shows the first suction cup 191 being larger in diameter than the second suction cup 192. In one example, the first suction cup 191 has a diameter of 50 mm whereas the second suction cup 192 has a diameter of 30 mm.

Where the suction cup assembly includes a plurality of suction cups, size and/or compliance differences between the respective suction cups allow for a given suction cup of the plurality to be selected for a given grasping task. For example, in a range of items to be grasped, softer items (e.g. pasta bags) can have more resilient grasps whereas larger/flatter items (e.g. horizontal pizza boxes or tortilla packs) can be more stable. A larger suction cup (e.g. 50 mm diameter) can be useful when grasping a larger or heavier item but can make items with smaller top areas (e.g. bottles or cartons) more difficult to grasp. Larger cups can also increase the occurrence of “double picking”, i.e. grasping more than one item at a time, compared to smaller cups. Smaller (e.g. 30 mm diameter) cups are naturally better at singulating smaller items (e.g. packed jello boxes), however they may struggle maintaining a stable grasp on the larger/heavier items in the range, particularly under acceleration as the robot arm moves during the grasping phase. Having a choice of suction cups 191, 192 as part of the suction cup assembly 164 can thus increase the range of items that are graspable by the end effector 156, on top of the benefits of having the suction cup assembly 164 be pivotable.

In this aspect, the pivotable suction cup assembly 164 is fluidically connectable to a vacuum stem, e.g. the extendable stem 165 described with reference to FIGS. 7A-7C, arranged to supply vacuum pressure to the suction cup assembly 164. The pivotable nature of the suction cup assembly 164 allows the end effector 156 to pick items on surfaces that are not normal to the vacuum stem 165, which would be the norm for a fixed suction cup at the end of the stem 165. Being able to pivot the suction cup assembly 164 also means that an item grasped with a suction cup of the suction cup assembly can be reoriented to make placement or packing of the item easier in certain situations.

### Valve Assembly

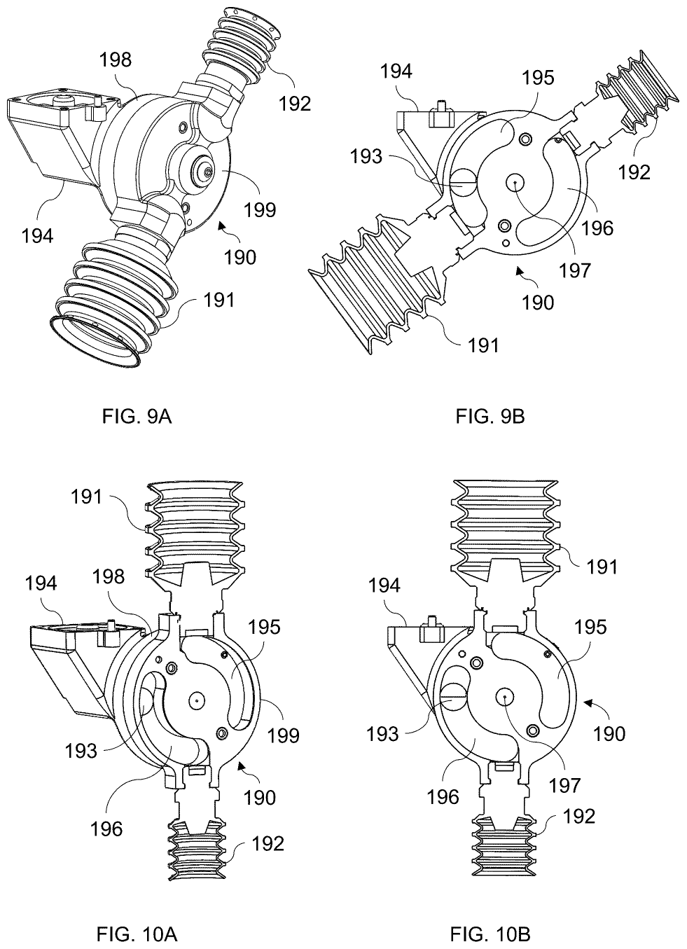

In a further aspect, there is provided a suction cup assembly for a robot end effector, e.g. one of the end effector embodiments described with reference to FIGS. 7-8. The suction cup assembly, in accordance with the embodiment illustrated in FIGS. 9A-B and 10A-B, comprises a first suction cup 191, a second suction cup 192, and a valve assembly 190.

The valve assembly 190 comprises an inlet 193 to which vacuum pressure is supplied in use, e.g. via an attachment 194 to connect the valve assembly to a vacuum stem such as the extendable stem 165 described in examples. The valve assembly 190 also has a first flow channel 195 in fluid communication with the first suction cup 191, and a second flow channel 196 in fluid communication with the second suction cup 192. The first and second flow channels 195, 196 are movable to activate the first or second suction cup 191, 192, in dependence on alignment of the inlet 193 with the respective first or second flow channel 195, 196 when the vacuum pressure is activated.

In the embodiment depicted in FIGS. 9A-B and 10A-B, the first and second suction cups 191, 192 are angularly offset about the valve assembly 190. The valve assembly 190 is rotatable, e.g. about its central axis 197, to move the first and second flow channels relative to the inlet. Other arrangements are possible, for example where linear movement of the first and second flow channel 195, 196 changes the alignment with the inlet 193 rather than angular movement.

As described for examples of the pivotable suction cup assembly with reference to FIGS. 7A-C, the two suction cups 191, 192 may be at least one of a different size or compliance to one another. Having a choice of at least two suction cups 191, 192 as part of the suction cup assembly has benefits in relation to the range of items that can be stably grasped.

In operation, a motor or other actuator (not shown) rotates the valve body to any angle to point one of the two suction cups 191, 192 in a desired direction. Vacuum flow, e.g. supplied via a stem connected to the attachment 194, is routed to either the first (e.g. larger) suction cup 191 or second (e.g. smaller) suction cup 192 depending on the angle of the rotating body-vacuum flows through the cup 191, 192 that is pointed down or forward (or anywhere in between).

For example, FIGS. 9A-B show a configuration where the body of the valve assembly 190 has been rotated into a position in which the inlet 193 is aligned with the first flow channel 195 in fluid communication with the first suction cup 191. Thus, when vacuum pressure is supplied to the inlet 193, the first suction cup 191 is activated for releasably engaging an item by suction in the normal way. The first suction cup 191 can remain activatable through a given angle of rotation of the valve assembly 190 that is set by the arc length of the first flow channel 195. The same applies for the second suction cup 192 and the second flow channel 196. FIGS. 10A-B, for example, show another configuration in which the body of the valve assembly 190 has been rotated into a position where the inlet 193 is aligned with the second flow channel 196 in fluid communication with the second suction cup 192. Thus, when vacuum pressure is supplied to the inlet 193 in this configuration, the second suction cup 192 is activated.

The valve 190 can be rotated with vacuum either on or off and while the gripper is either holding or not holding an item. This can be useful to pick items on surfaces not normal to the vacuum stem or to re-orient a grasped item for easier packing, for example.

In the specific embodiment of FIGS. 9A-B and 10A-B, the valve assembly 190 comprises a first part 198 comprising the inlet 193 and a second part 199 comprising the first and second flow channels 195, 196. The first and second parts 198, 199 are rotatable relative to each other to move the first and second flow channel 195, 196 relative to the inlet 193. For example, one of the parts (e.g. the first part 198 comprising the inlet 193) may be fixed as part of the suction cup assembly, while the other of the parts (e.g. the second part 199 also comprising the first and second suction cups 191, 192) is rotatable to move the flow channels 195, 196 relative to the inlet 193.

As described with reference to the embodiment of FIG. 8, a belt drive may be employed to rotate at least one of the first and second parts 198, 199 relative to the other. For example, the suction cup assembly may include a pulley (not shown) for the belt drive, e.g. attached to an axle for the second part 199 such that rotation of the pulley by the belt drive causes rotation of the second part 199 relative to the first part, thus moving the flow channels 195, 196 relative to the inlet 193.

The skilled reader will appreciate that the first and second flow channels 195, 196 may be movable by another motor arrangement in other embodiments, e.g. a direct motor coupling, and may involve linear rather than angular actuation.

In examples, the suction cup assembly includes a proximity sensor to signal a preset position of the movable first and second flow channels 195, 196. For example, similarly to the extension mechanism for the stem 165 described with reference to FIGS. 7A-C, a preset “zero” position of the second part 199 is determinable using a proximity (or “home”) sensor at a set position on the first part 198, with the relative position of the two parts 198, 199—and thus the position of the first and second flow channels 195, 196 relative to the inlet 193—incrementally trackable from there.

In a specific example, the zero position of the rotating valve assembly 190 is determined by an inductive homing sensor and the valve position is tracked directly from a magnetic absolute encoder connected to the driving motor for the valve assembly 190. Once the encoder offset is determined, the homing sensor does not need to be re-triggered after a power reset.

### Exhaust Element

In another aspect, there is provided a robot end effector comprising a vacuum manifold with an integrated vacuum source (e.g. in accordance with some of the embodiments described with reference to FIGS. 7A-7C) and an exhaust element connectable to the vacuum manifold to direct an exhaust of the vacuum generator from the vacuum manifold in use.

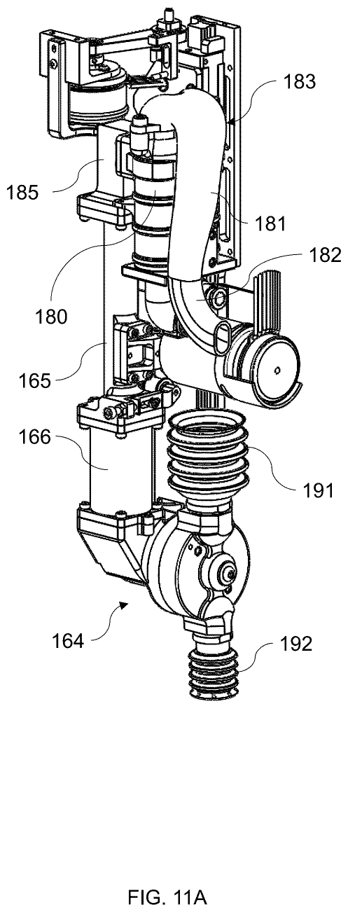

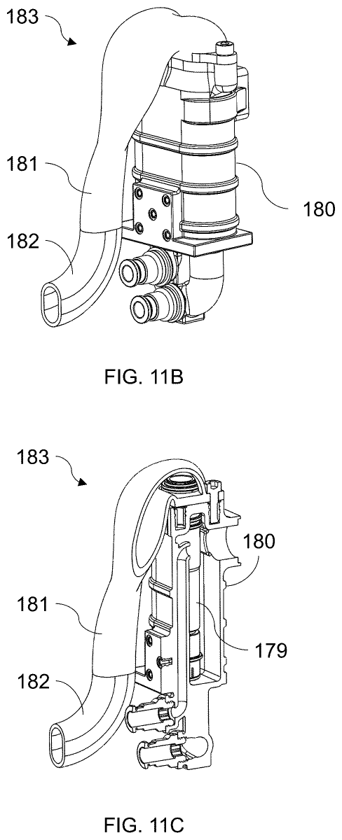

FIGS. 11A-C show an example of an exhaust element 183 connectable to the vacuum manifold 180 housing a vacuum generator 179, e.g. a venturi generator. The exhaust element 183 is configured to direct an exhaust of the vacuum generator 179 from the vacuum manifold 180 during operation of the vacuum generator 179.

When the end effector is assembled, e.g. as shown in FIG. 11A, such that the vacuum stem 165 is at least fluidically connected to the vacuum manifold 180, the exhaust element 183 comprises a segment 181 aligned with the stem 165. For example, the major segment 181 of the exhaust element 183 shown in FIG. 11A is aligned with the stem 165 which provides vacuum pressure to the suction cup assembly 164 during operation of the end effector. Thus, while the vacuum generator 179 is operating, the exhaust of the vacuum generator 179 flows towards the suction cup assembly 164 when passing through the segment 181 of the exhaust element 183. For example, in the embodiment shown in FIGS. 11A-C, the exhaust of the venturi vacuum generator 179 housed in the manifold 180 would flow through the segment 181 of the exhaust element 183 in the opposite direction to the flow of pressurised air through the venturi generator 179. In other words, the exhaust element 183 reverses the direction of air flow exiting the vacuum generator 179. This can help protect components of the end effector that are positioned near the top of the stem 165, e.g. above the vacuum manifold 180 which may be mounted thereto, from the exhaust of the vacuum generator 179. For example, liquids may be sucked up from the suction cup assembly 164, through the stem 165, and into the vacuum manifold 180. Subsequent operation of the vacuum manifold 180, e.g. the one or more vacuum generators 179 being turned on for the next picking operation, may then cause the liquid contaminant to be expelled by the vacuum manifold 180 over other, e.g. electrical, components of the gripper. The described exhaust element 181 helps redirect the exhaust of the vacuum generator(s) 179 away from the end effector to reduce the risk of contaminating components thereof when contaminants end up in the vacuum manifold 180.

In examples, the described segment is a first segment 181, and the exhaust element 183 includes a second segment 182 downstream of the first segment 181, as shown in the embodiment of FIGS. 11A-C. The second segment 182 may be shaped to direct the exhaust of the vacuum generator away from the vacuum stem 165 during operation. For example, the airflow direction outputted from the second segment 182 of the exhaust element 183 is substantially perpendicular to the longitudinal axis of the vacuum stem 165. In this way, the exhaust is not released towards the suction cup assembly 164.

In described examples, the vacuum manifold 180 may be configured to house a plurality of vacuum generators 179. Thus, the exhaust element 182 may include a plurality of input channels, corresponding to the plurality of vacuum generators, as shown in FIGS. 11A-C. The exhaust element 182 may also have a single output channel, thus configured as an exhaust manifold to consolidate the multiple vacuum generator exhaust flows into a single output flow that is directed from the manifold 180 as described.

### Finger Gripper Assembly

In a further aspect, there is provided a robot end effector having a finger gripper assembly comprising a first finger element, a second finger element, and a drive mechanism to open and close the first and second finger elements relative to each other.

FIGS. 12A-B show an embodiment in which the example end effector described with reference to FIGS. 7-8 further includes such a finger gripper assembly 200 having a first finger element 201 and a second finger element 202 for releasably gripping an item. The finger gripper assembly 200 also includes a drive mechanism 203 which functions to move the first and second finger elements 201, 202 towards or away from each other during operation, e.g. to bring them together for gripping the item therebetween.

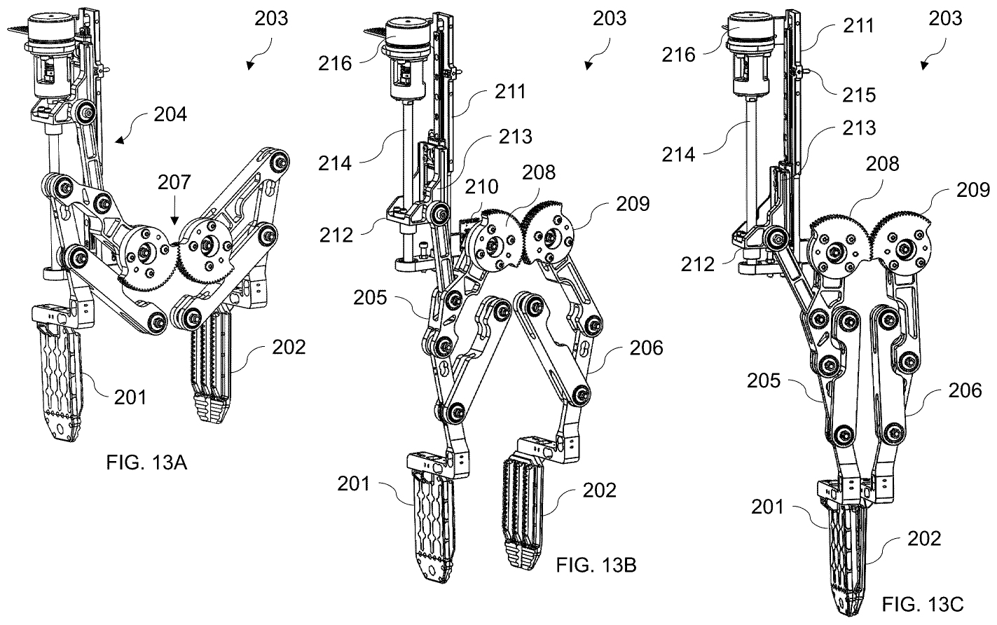

FIGS. 13A-C show the finger gripper assembly in isolation to illustrate how the drive mechanism 203 operates. The drive mechanism 203 includes an actuator 204 and a first linkage assembly 205 connecting the actuator 204 to the first finger element 201. The connection of the first linkage assembly 205 to the actuator 204 provides direct actuation of the first finger element 201 by the actuator 204. A second linkage assembly 206 and gear mechanism 207 is provided to connect the actuator 204 to the second finger element 202 for passive, e.g. dependent, actuation thereof by the actuator 204. The first and second linkage assemblies 205, 206 each comprise multiple pivotable links, for example, where the pivot joints comprise radial ball bearings.

In the example of FIGS. 13A-C, the gear mechanism 207 includes a first gear 208 connected to the first linkage assembly 205 and a second gear 209 connected to the second linkage assembly 206. The second gear 209 is arranged to mesh with the first gear 208 so as to actuate the second finger element 202 in dependence on actuation of the first finger element 201 by the actuator 204.

Having the actuation of the second finger element 202 as dependent on the actuation of the first finger element 201 allows for a simplified construction of the finger gripper assembly. For example, a single actuator with one motor 216 is utilised compared to individually motorising the respective fingers. This can help reduce the size and weight of the end effector while still providing parallel jaw gripping capabilities. In the context of a combination gripper having additional gripping functionality, e.g. a suction device, the integrated actuation of the finger elements 201, 202 may provide more space for other components relating to the additional gripping functionality.

The actuator 204 in the depicted embodiment comprises a ball screw actuator similar to that described for actuating the extendable stem 165 in the embodiment shown in FIGS. 7A-C. The ball screw actuator 204 has a ball screw nut 212 movable along a ball screw shaft 214 that is rotatable about its longitudinal axis by a motor 216 (e.g. a DC motor). The motor 216 is directly coupled to the ball screw shaft 214 in this example, but may alternatively drive the shaft 214 by a gear mechanism or belt drive to provide the rotational motion. The first linkage assembly 205 is connected to the movable nut 212 such that linear movement of the nut 212 along the ball screw 214 directly actuates the first finger element 201 between its open and closed positions. FIG. 13A shows the first linkage assembly 205 in a more retracted position with the first finger element 201 in its most open position, whereas FIG. 13C shows the first linkage assembly 205 in a more extended position with the nut 214 having travelled towards the lower end of the shaft 204 of the ball screw actuator 204 to move the first finger element 201 into its most closed position relative to the second finger element 202.

In this example, the actuator 204 further comprises a guide rail 211 and a carriage assembly 213, movably mounted to the guide rail 211, to which the ball screw nut 212 is connected. The guide rail 211 functions, at least in part, to guide the linear movement of the ballscrew nut 212 to extend or unfurl the first linkage assembly 205 when closing the gripper and to retract or fold the first linkage assembly 205 when opening the gripper. The second linkage assembly 206 mirrors the first linkage assembly 205 in its construction and function, for example, but without the connecting link to the ballscrew nut 212; its movement being dependent on that of the first linkage assembly 205 via the gear mechanism 207.

In examples, an absolute encoder 210 (e.g. magnetic encoder) is located on the first linkage assembly 205, e.g. on an upper link or adjacent the first gear 208, to directly track a position of the finger gripper assembly. Additionally, or alternatively, the position of the mechanism is tracked by hall effect motor rotation of the Brushless DC (BLDC) electric motor 216.

A home sensor 215 may be employed like in other described embodiments. For example, a preset “zero” position for the finger gripper assembly can be determinable using the home sensor 215 (e.g. positioned on the guide rail 211 at the top of the ball screw mechanism 204 stroke), with the position then tracked incrementally from there using e.g. the encoder 210.

In some examples, at least the first linkage assembly 205 includes an instrumented link, e.g. a link equipped with sensors or instrumentation to measure various physical parameters such as forces or torques during operation. This allows for real-time monitoring and feedback, enabling the robot to perform tasks with greater precision and adaptability.

When not in use, the fingers 201, 202 are retractable into the gripper, e.g. until the home sensor 211 is triggered. Prior to a grasp, the fingers 201, 202 are extendable to a pre-grasp opening size, e.g. under position control of a motor controller. During the grasp, the fingers 201, 202 may be closed under a force-control mode based on feedback from the motor controller and/or instrumented link.

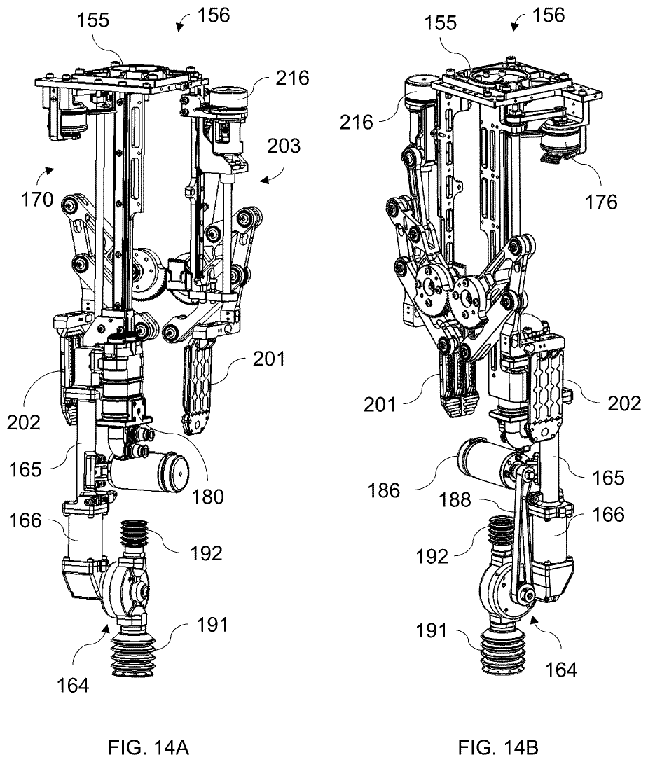

With further reference to FIGS. 14A-B, two more isometric views are shown of the combination gripper embodiment of the end effector 156 described with reference to FIGS. 12A-B. The illustration of this embodiment shows a connector or mounting 155 for connecting or mounting the end effector 156 to a robotic arm, e.g. the robotic arm 54 described as part of the on-grid picking station 50 depicted in FIG. 6. The end effector 156 shown in FIGS. 12A-B and 14A-B combines multiple aspects previously described, in particular: the extendable stem 165 with mounted vacuum manifold 180 for grasping by suction; and the finger gripper assembly 200 for grasping with fingers 201, 202. Thus, two independent modes of grasping are provided for the combination end effector 156.

For example, with the finger gripper assembly 200 retracted and the vacuum stem 165 extended, as shown in FIGS. 14A-B, an item may be more easily isolated, e.g. from a group of items, during a picking operation. Similarly, during placement, the less bulky profile of the end effector 156 near the grasped item can make placing the item into a given space easier, e.g. without disrupting other objects in the vicinity. The same benefits may apply to scanning the item after picking before placing—e.g. where the grasped item includes a scannable marker the suction-only grasp by the end effector 156 can allow for more of the object to be seen by a scanner without obstruction from other parts of the gripper.

The combined end effector 156 also allows for transferring the grasp of the item at least partially to the finger gripper assembly 200, e.g. even if suction is initially used less compressed air can be consumed for the grasp operation by transferring the item to the finger elements 201, 202, compared with a suction-only grasp. The finger gripper assembly 200 may also be used to stabilise an item grasped by a suction cup 191, 192 of the suction cup assembly 164. For example, larger or heavier items may cause the suction-only mode of the gripper to lose its seal, especially with acceleration/deceleration of the robot arm after the initial grasp. Thus, having the finger elements 201, 202 also grasp the item, the seal of the suction cup 191, 192 with the grasped item may be better maintained during motion of the robot arm prior to placement of the item.

By employing the pivotable suction cup assembly 164 as part of the combined end effector 156, the grasped item may also be reoriented more easily, e.g. as part of the picking, placing, or transferring of the item. Similarly, employing the described valve assembly 190 may allow for one of a plurality of selectable suction cups to be activated for grasping the item.

For some items, it may be preferable to grasp them without suction at all, e.g. due to their size, weight, material. In such cases, the end effector 156 may utilise only the finger gripper assembly 200 to grasp the item. As shown in FIGS. 12A-12B, the linkage assemblies 205, 206 can be actuated to close the finger elements 201, 202 in the space below the retracted suction cup assembly 164, for example.

Overall, the combination gripper 156 employing both the extendable suction mechanism and the finger gripper assembly can increase the range of stably graspable items relative to a gripper employing only one of the systems.

The present disclosure describes examples of how the invention may be practised, and it will be appreciated by those skilled in the art that a variety of approaches may be adopted without departing from the scope of the invention as defined by the appended claims.

The above examples are to be understood as illustrative; further examples are envisaged.

For instance, the pivotable suction cup assembly 164 may comprise an integrated cutting element, e.g. a safety blade, for use in opening packaging. Thus, the suction cup assembly 164 may be pivoted and/or moved to cut the packaging of a packaged item with the cutting element prior to grasping the item with the suction assembly 164 and/or finger gripper assembly 200 where present. Other such tools may be incorporated with the one or more suction cups on the suction cup assembly 164.

A camera may be employed to view the pivotable suction cup assembly 164 in envisaged examples. The end effector 156 described in any of the above examples may include a mount for a camera, for example. The one or more suction cups of the pivotable suction cup assembly 164 may thus be inspected, e.g. for damage such as tears or to determine whether something is stuck inside it, by pivoting the suction cup assembly 164 in view of the camera.

Any of the end effector embodiments described herein may be employed as part of a robotic manipulator, e.g. used in a picking station of a storage and retrieval system. For example, an on-grid robotic picking station like the one shown in FIG. 6 may comprise a robotic manipulator incorporating one or more aspects of the described example end effectors.

Various examples can be realised which include combinations of features of the originally filed claims, as indicated in the following table, which lists various envisaged claim dependencies for the claims originally filed with this application. Hence, in addition to the description above, this table gives basis in the specification for general examples including a combination of features of the original claims appended hereto:

| Claim originally filed | Envisaged claim dependencies |
|---|---|
| 1 | — |
| 2 | 1 |
| 3 | 1 or 2 |
| 4 | any one of claims 1 |
| 5 | any one of claims 1 |
| 6 | any one of claims 1 |
| 7 | any one of claims 1 |
| 8 | any one of claims 1 |
| 9 | 8 |
| 10 | 9 |
| 11 | — |
| 12 | 11 |
| 13 | 12 |
| 14 | 13 |
| 15 | 14 |
| 16 | any one of claims 12 |
| 17 | any one of claims 11 |
| 18 | 17 |
| 19 | 18 |

1. A suction cup assembly for a robot end effector, the suction cup assembly comprising:
a first suction cup;
a second suction cup; and
a valve assembly comprising an inlet and first and second flow channels in respective fluid communication with the first and second suction cups;
wherein the first and second flow channels are movable to activate the first or second suction cup, in dependence on alignment of the inlet with the respective first or second flow channel, when vacuum pressure is supplied to the inlet in use.

2. The suction cup assembly of claim 1, wherein:
the first and second suction cups are angularly offset about the valve assembly; and
the valve assembly is rotatable to move the first and second flow channels relative to the inlet.

3. The suction cup assembly of claim 2, wherein the valve assembly comprises a first part comprising the inlet and a second part comprising the first and second flow channels, the first and second parts being rotatable relative to each other.

4. The suction cup assembly of claim 1, wherein the first suction cup is of a different size to the second suction cup.

5. The suction cup assembly of claim 1, wherein the first suction cup is of a different compliance to the second suction cup.

6. The suction cup assembly of claim 1, further comprising a proximity sensor to signal a preset position of the movable first and second flow channels.

7. The suction cup assembly of claim 1, further comprising a pulley for a belt drive.

8. An end effector for a robotic manipulator comprising the suction cup assembly according to claim 1.

9. A robotic manipulator comprising the end effector according to claim 8.

10. An automated storage and retrieval system comprising the robotic manipulator according to claim 9.

11. A robot end effector comprising:
a finger gripper assembly; and
a suction cup assembly comprising:
a first suction cup;
a second suction cup; and
a valve assembly comprising an inlet and first and second flow channels in respective fluid communication with the first suction cup and second suction cup;
wherein the first and second flow channels are movable to activate the first or second suction cup, in dependence on alignment of the inlet with the respective first or second flow channel, when vacuum pressure is supplied to the inlet in use.

12. The robot end effector of claim 11, further comprising an extendable stem to which the suction cup assembly is fluidically connected so as to be movable relative to the finger gripper assembly.

13. The robot end effector of claim 12, wherein a vacuum manifold is mounted on the extendable stem to move therewith, the vacuum manifold being fluidically connected to the extendable stem.

14. The robot end effector of claim 13, wherein the vacuum manifold comprises an integrated vacuum source to supply the vacuum pressure to the inlet of the suction cup assembly, via the vacuum manifold and the extendable stem, in use.

15. The robot end effector of claim 14, wherein the integrated vacuum source comprises one or more venturi vacuum generators.

16. The robot end effector of claim 12, wherein the extendable stem comprises an inline filter assembly in fluid connection with the suction cup assembly.

17. The robot end effector of claim 11, the finger gripper assembly comprising:
a first finger element;
a second finger element; and
a drive mechanism to open and close the first and second finger elements relative to each other.

18. The robot end effector of claim 17, wherein the drive mechanism comprises:
an actuator;
a first linkage assembly connecting the actuator to the first finger element for direct actuation of the first finger element; and
a second linkage assembly and gear mechanism connecting the actuator to the second finger element for passive actuation of the second finger element.

19. The robot end effector of claim 18, wherein the gear mechanism comprises:
a first gear connected to the first linkage assembly; and
a second gear connected to the second linkage assembly and arranged to mesh with the first gear to passively actuate the second finger element in dependence on actuation of the first finger element by the actuator.
